(19) United States
(12) Patent Application Publication
(10) Pub. No.: US 2010/0018784 A1
(43) Pub. Date: Jan. 28, 2010

(54) Vehicle with electric motor and method for designing said vehicle

(75) Inventor: Rudolf Hoebel, Egling (DE)

Correspondence Address: EAGLE IP LIMITED, 13/F, Bright Way Tower, 33 Mong Kok Road, Kowloon, HK

(73) Assignee: CLEAN MOBILE AG, Unterhaching (DE)

(21) Appl. No.: 12/522,712

(22) PCT Filed: Dec. 28, 2007
(86) PCT No.: PCT/IB07/55331

§ 371 Date: Jul. 10, 2009

(30) Foreign Application Priority Data
Jan. 12, 2007 (DE) 102007002610.4

(51) Int. Cl. B60L 8/00; B60K 1/00; B60K 6/20; B62K 11/00; B62D 61/06

(52) U.S. Cl. 180/2.2; 180/65.51; 180/65.21; 180/220; 180/210

(57) ABSTRACT

A vehicle operated by an electric motor (16) comprises an energy generating unit (11, 12, 16) for generating electric energy for the electric motor (16) and an energy storage device (8, 9) for storing electric energy, wherein the energy storage device (8, 9) is connected to the electric motor (16) for supplying the electric motor (16) with electric energy in addition to the energy supplied by the energy generating unit (11, 12, 16). The maximum power which can be provided by the energy generating unit (11, 12, 16) is higher, but by no more then 15%, than an average motor power in the operation of the vehicle.

The invention relates to a vehicle with an electric motor, such as a two-wheeled vehicle with an electric motor or an electrically driven wheelchair. It further relates to a method for designing a vehicle of this type.

An electrically driven wheelchair with a hybrid drive with a fuel cell and a lithium ion battery is known from WO 2006/019030 A1. A similar hybrid drive is known from DE 195 24 416 A1 and DE 198 13 146 A1.

DE 101 11 518 A1 discloses an electric motor with a particularly high overload capacity. From DE 101 37 774 A1, the provision of a separate starter for starting an internal combustion engine in a hybrid drive in order to keep the electric motor as small and light-weight as possible is known.

There is a need to provide electric drives for other vehicles and different applications as well and in particular to optimise them for better utilisation.

The invention is therefore based on the problem of specifying an improved drive unit for a vehicle with an electric motor. The invention is further based on the problem of specifying a method for designing a vehicle of this type.

This problem is solved by the subject matter of the independent claims. Advantageous further developments can be derived from the dependent claims.

A vehicle according to the invention comprises an electric motor connected to at least one wheel of the vehicle in order to drive it. The vehicle further comprises an energy generating unit for generating electric energy for the electric motor from a provided energy source and an energy storage device for storing electric energy generated by the energy generating unit, wherein the energy storage device is connected to the electric motor to supply the electric motor with electric energy in addition to the electric energy provided by the energy generating unit. The maximum power which can be provided by the energy generating unit is higher, but by no more than 15%, than the average motor power in the operation of the vehicle.

The average motor power in the operation of the vehicle in this context is the mean motor power during a specified loading of the vehicle. For this purpose, the vehicle, with respect to its application (e.g. transport of a single person in urban traffic), is designed such that the maximum power which can be provided by the energy generating unit does not substantially exceed the average motor power. This offers the advantage that there is no need for an excessively powerful and therefore typically heavy energy generating unit, resulting in weight and therefore energy savings.

The application of the vehicle is characterised by a predetermined route and a planned speed profile. It is based on a typical route of a typical user with a typical speed profile. The vehicle according to the invention may be designed for various applications, for example for short journeys in urban traffic characterised by a level route and frequent stopping and starting, or for longer cross-country journeys with higher peak speeds and gradients. Such different applications involve different typical power profiles and therefore different requirements in the selection of the energy generating unit and the selection of the energy storage device.

In one embodiment, the maximum power which can be provided by the energy generating unit exceeds the average motor power of the vehicle by no more than 10%. This embodiment permits the use of an energy generating unit with a lower maximum power, which will therefore be lighter than an energy generating unit which provides up to 115% of the average motor power.

If weight is particularly important, the maximum power which can be provided by the energy generating unit is higher than the average motor power of the vehicle, but by no more than 5% or even 1%. The optimum selection of the maximum power which can be provided requires a very precise knowledge of the application of the vehicle, i.e. its routes and speed profiles. The better the application is known, the closer the maximum power which can be provided by the energy generating unit can be matched to the average motor power, because peak loads are buffered by well-chosen energy storage devices. As a result, a particularly light-weight energy generating unit can be selected. In this embodiment of the vehicle, the energy storage device will be empty or at least almost empty at certain times on a given route.

If the maximum power which can be provided by the energy generating unit exceeds the average engine power by more than 1% or 5% but by less than 15%, a slightly “oversized” energy generating unit is used, but this offers the advantage that the application of the vehicle does not have to be defined so closely and is more flexible.

According to an idea on which the invention is based, the energy generating unit has to provide only slightly more than the average motor power if readily available energy is stored in an energy storage device to cope with peak demands. In this case, the vehicle can be driven using the energy provided by the energy generating unit while any energy which is currently not required can be stored in the energy storage device to be made available in periods of peak loading. For this purpose, the energy storage device is advantageously connected to the energy generating unit and can be charged by the latter.

These measures provide a vehicle which is particularly light-weight owing to its aptly designed energy generating unit, which saves energy.

In an advantageous embodiment, the electric motor recovers energy when braking in the recuperative mode and stores the recovered energy in the energy storage device. In this embodiment, further energy is saved by using energy which would otherwise be converted into friction for charging the energy storage device.

In one embodiment, the energy generating unit is designed as a fuel cell. As a fuel cell operates most efficiently at high power, it can be combined with an energy storage device to particularly good effect. In alternative embodiments, the energy generating unit is designed as an internal combustion engine with a generator or as a photovoltaic cell.

In one embodiment, the energy storage device is designed as a capacitor, in an alternative embodiment as a battery.

Particular advantages are offered by the combination of at least one battery and at least one capacitor to provide an energy storage device in a further embodiment. For this purpose, the battery, for example a lithium ion battery or a lead acid battery, and the capacitor are connected in parallel, the capacitor being advantageously provided with a series resistor. While the battery can offer a comparably high capacity, the capacitor is charged and discharged very quickly. In a combination, the advantages of both types of energy storage can be used. In addition, the use of the capacitor may extend the service life of the battery, for example by buffering peak currents occurring in the recuperation process.

In one embodiment, the vehicle according to the invention is designed as a wheelchair and comprises at least two wheels and a frame with a seat for a user.

In an alternative embodiment, the vehicle is designed as a two-wheeled vehicle with a front wheel and a rear wheel and comprises a frame and a seat for a user and a handle bar. The vehicle may alternatively be three-wheeled with one front wheel and two rear wheels or with two front wheels and one rear wheel, comprising a frame and a seat for a user and a handle bar.

In one embodiment, the vehicle includes a device for generating additional energy by the mechanical effort of the user.

The vehicle according to the invention offers the particular advantage that it can be operated in an energy-saving manner owing to the combination of an energy generating unit with an energy storage device and owing to the matching of the energy generating unit to the energy storage device and the optimising of the vehicle in terms of overall weight.

Energy can be recovered and stored optimally in a recuperative mode using an energy storage device comprising both a battery and a capacitor, without risking the overloading of the battery and the reduction of its service life.

A method according to the invention for designing a vehicle with an electric motor, an energy generating unit for generating electric energy for the electric motor and an energy storage device for storing electric energy comprises the following process steps: First, a typical power profile for the operation of the vehicle is determined. This may be achieved by means of a simulation or empirically by evaluating empirical values or carrying out additional tests. In this process, the application for which the vehicle is to be designed is specified. Particular consideration is given to the transport of individual persons and small loads, for example in urban or other short-distance traffic. The typical power profile includes information on peak loads, parking time of the vehicle and the duration of specified power demands.

From the typical power profile determined in this way, the average power to be provided by the electric motor is then calculated, i.e. the power from the typical power profile which has been determined is averaged over time. The energy generating unit is dimensioned such that the maximum power of the energy generating unit lies in the range of the power to be provided by the electric motor on average.

In this process, the energy generating unit is dimensioned such that its maximum power is higher than average power, but by no more than 15%, preferably 10%, even more preferably 5% and even more preferably 1%.

In one embodiment, the typical power profile is determined from the typical route and a desired speed profile.

The method advantageously comprises the following additional steps: A peak power of the power profile which occurs in the operation of the vehicle and the additional energy which is required for the operation of the electric motor at peak power in addition to the energy supplied by the energy generating unit are determined. The energy storage device is dimensioned such that its capacity is at least equal to the additional energy demand.

Embodiments of the invention are explained in greater detail below with reference to the accompanying figures.

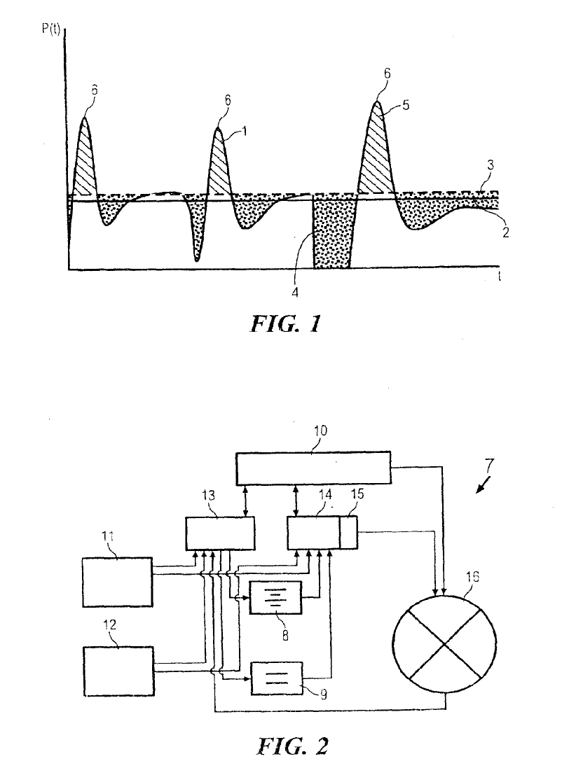

FIG. 1 is a graph of a typical power profile of a vehicle according to an embodiment of the invention;

FIG. 2 is a schematic circuit diagram of a drive unit according to the invention for a vehicle with an electric motor; and

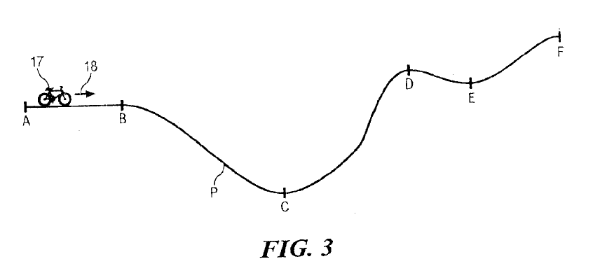

FIG. 3 is a diagrammatic representation of a route for a vehicle with an electric motor.

FIG. 1 plots the motor power P to be provided by the vehicle according to the invention in operation versus the time t as line 1. The same diagram shows the motor power P averaged over the time t as line 2.

In operation, the vehicle has to cope with peak loads at certain times, for example when starting, when travelling uphill or when accelerating. In conventional vehicles, the motor is designed to deliver the power required for peak loads 6.

In contrast, the vehicle according to the invention has an energy generating unit which supplies the electric motor with energy and which can deliver a maximum power which is higher, but by no more than 15%, than the average motor power P used in the operation of the vehicle. The maximum power which can be provided by the energy generating unit is represented by the broken line 3 in the diagram. This means that the energy generating unit is not capable of delivering the power required for peak loads 6.

Instead of this, the vehicle according to the invention is provided with energy storage devices which supply the electric motor with electric energy in addition to the energy provided by the energy generating unit, if required. In particular at times of peak loads 6, these energy storage devices can be “selected” to make the required energy and power available for short periods.

In the vehicle according to the invention, the energy generating unit can be operated such that it provides a constant power, i.e. the power P+ΔP, wherein ΔP is constant and positive and amounts to between 1% and 15% of P. This is particularly advantageous if a fuel cell is used, which operates most efficiently under maximum loads and moreover has a very long service life at constant loading.

With a time-dependent power profile P(T) and a constant available power P+ΔP, the instantaneous energy demand of the electric motor only rarely equals the available energy. In several periods of time which are represented as dotted regions 4 in FIG. 1, the energy generating unit delivers more instantaneous energy than the electric motor requires. This surplus energy is stored in the energy storage device.

In other periods represented as hatched regions 5 in FIG. 1, this energy can be supplied to the electric motor in addition to the energy provided by the energy generating unit in order to cope with peak loads.

FIG. 2 is a schematic circuit diagram of a drive unit 7 according to the invention for a vehicle with an electric motor. In the illustrated embodiment, this vehicle is a bicycle with an electric motor. It may alternatively be a battery-operated wheelchair or a car with an electric motor.

The drive unit 7 comprises a battery 8, a capacitor 9, a charge controller 13, a motor controller 14, a drive control unit 10, a generator 12, an electric motor 16, a power electronics unit 15 and a fuel cell 11.

The energy sources or energy generating units (fuel cell 11, generator 12 and recuperation feed 16) are connected to the energy storage devices (power-matched battery 8 and capacitor 9) via the charge controller 13. The fuel cell 11 is designed such that the maximum power it can provide is higher, but by no more than 15%, than the average motor power P in the operation of the vehicle. The additional power required at peak loads is taken from the energy storage devices 8 and 9. The battery 8 may be a lithium ion battery or a lead acid battery. In the illustrated embodiment, the capacitor 9 is an electro-chemical double layer capacitor with a very high capacitance and energy density.

The charge controller 13 controls the charge of the energy storage devices 8 and 9 in dependence on the power input of the motor 16 and the available energy of the energy sources 11, 12 and 16, taking account of the ideal charge characteristics of each storage device.

The motor 16 is driven and controlled by way of the power electronics unit 15. The motor controller 14 takes account of the required drive power predetermined via the drive control unit 10.

In this process, the motor 16 acquires the required energy from the storage devices 8 and 9 in dependence on the route profile and the instantaneous power input of the motor 16.

Superimposed in the drive control unit 10 are the power data of the energy generating units 11, 12 and 16 and the ideal charge characteristics of the energy storage devices 8 and 9. The drive control unit 10 further contains motor characteristics which are forwarded to the motor controller 14.

FIG. 3 shows a route for a vehicle with an electric motor, the vehicle being a bicycle 17 with an electric motor. The bicycle 17 is intended to travel a route with an elevation profile P from A to F in the direction of travel 18. From point A, the journey is level to point B, then downhill between points B and C, followed by a first rise D. From D, the journey is slightly downhill to point E, followed by a second rise to the destination F.

Along the flat section between points A and B, the bicycle 17 takes the required energy from the energy generating unit. As there are no peak loads due to uphill gradients in this section, there is no need for energy from the energy storage device at moderate travelling speeds.

From point B, the bicycle 17 travels downhill. This downhill gradient allows a switch-over to recuperative mode. In the recuperative mode, the vehicle is braked, but energy is recovered and can be stored in the energy storage device if this is not completely full.

Between points C and D, the bicycle has to cope with an uphill gradient. The required energy is taken from the energy generating unit and, if this is insufficient because of the gradient and/or because of the travelling speed, from the energy storage device. In terms of the capability of its energy generating unit and the capacity of its energy storage devices, the bicycle 17 is designed such that it can cope with the uphill gradient to point D, but not with any great “reserve power”, because an unnecessarily powerful energy generating unit would add a lot of weight to the bicycle 17. At point D, the energy storage device is empty or almost empty.

As a result, the bicycle 17 cannot accelerate strongly at or near point D. In order to make this nevertheless possible, the bicycle 17 could indicate the low state of charge before reaching point D by means of a display or an audible warning, enabling the cyclist to reduce his travelling speed and thus the energy taken from the energy storage device. If the vehicle is a bicycle with an auxiliary motor, the cyclist could be advised to operate the pedals by an indicating device.

Between points D and E, the bicycle 17 travels downhill and can therefore once again switch to recuperative mode and/or charge the energy storage device with surplus energy from the energy generating unit operating at constant power, so that the final uphill gradient to destination F can be traveled at an acceptable speed.

### LIST OF REFERENCE NUMBERS

1 Graph line
2 Graph line
3 Broken line
4 Dotted region
5 Hatched region
6 Peak load
7 Drive unit
8 Battery
9 Capacitor
10 Drive control unit
11 Fuel cell
12 Generator
13 Charge controller
14 Motor controller
15 Power electronics unit
16 Electric motor
17 Bicycle
18 Direction of travel
P Elevation profile

1. Vehicle with the following features:
an electric motor (16) connected for drive to at least one wheel of the vehicle;
an energy generating unit (11, 12, 16) for generating electric energy for the electric motor (16);
an energy storage device (8, 9) for storing electric energy, wherein the energy storage device (8, 9) is connected to the electric motor (16) to supply the electric motor with electric energy in addition to the electric energy provided by the energy generating unit (11, 12, 16); wherein the maximum power which can be provided by the energy generating unit (11, 12, 16) is higher, but by no more than 15%, than an average motor power P in the operation of the vehicle.

2. Vehicle according to claim 1, wherein the maximum power which can be provided by the energy generating unit (11, 12, 16) is higher, but by no more than 10%, than an average motor power P in the operation of the vehicle.

3. Vehicle according to claim 1, wherein the maximum power which can be provided by the energy generating unit (11, 12, 16) is higher, but by no more than 5%, than an average motor power P in the operation of the vehicle.

4. Vehicle according to claim 1, wherein the maximum power which can be provided by the energy generating unit (11, 12, 16) is higher, but by no more than 1%, than an average motor power P in the operation of the vehicle.

5. Vehicle according to claim 1, wherein the energy storage device (8, 9) is connected to and can be charged by the energy generating unit (11, 12, 16).

6. Vehicle according to claim 5, wherein the electric motor (16) recovers energy when braking in a recuperative mode and stores the recovered energy in the energy storage device (8, 9).

7. Vehicle according to claim 1, wherein the energy generating unit (11, 12, 16) is designed as a fuel cell.

8. Vehicle according to claim 1, wherein the energy generating unit (11, 12, 16) is designed as an internal combustion engine with a generator.

9. Vehicle according to claim 1, wherein the energy generating unit (11, 12, 16) is designed as a photovoltaic cell.

10. Vehicle according to claim 1, wherein the energy storage device is designed as a capacitor (9).

11. Vehicle according to claim 1, wherein the energy storage device is designed as a battery (8).

12. Vehicle according to claim 1, wherein the energy storage device comprises a battery (8) and at least one capacitor (9) connected in parallel with the battery (8).

13. Vehicle according to claim 1, wherein the vehicle is designed as a wheelchair and comprises at least two wheels and a frame with a seat for a user.

14. Vehicle according to claim 1, wherein the vehicle is designed as a two-wheeled vehicle with a front wheel and a rear wheel and comprises a frame with a seat for a user and a handle bar.

15. Vehicle according to claim 1, wherein the vehicle is designed as a three-wheeled vehicle with a front wheel and two rear wheels and comprises a frame with a seat for a user and a handle bar.

16. Vehicle according to claim 1, wherein the vehicle is designed as a three-wheeled vehicle with two front wheels and a rear wheel and comprises a frame with a seat for a user and a handle bar.

17. Vehicle according to claim 13, wherein the vehicle includes a device for generating additional energy by the mechanical effort of the operator.

18. Method for designing a vehicle with an electric motor (16), an energy generating unit (11, 12, 16) for generating electric energy for the electric motor (16) and an energy storage device (8, 9) for storing electric energy, the method comprising the following process steps:
the determination of a typical power profile for the operation of the vehicle;
the calculation of an average power P to be provided by the electric motor (16);
the dimensioning of the energy generating unit (11, 12, 16) such that the maximum power of the energy generating unit (11, 12, 16) lies within the range of the average power P.

19. Method according to claim 18, wherein the energy generating unit (11, 12, 16) is dimensioned such that its maximum power is higher, but by no more than 15%, than the average power P.

20. Method according to claim 18, wherein the energy generating unit (11, 12, 16) is dimensioned such that its maximum power is higher, but by no more than 10%, than the average power P.

21. Method according to claim 18, wherein the energy generating unit (11, 12, 16) is dimensioned such that its maximum power is higher, but by no more than 5%, than the average power P.

22. Method according to claim 18, wherein the energy generating unit (11, 12, 16) is dimensioned such that its maximum power is higher, but by no more than 1%, than the average power P.

23. Method according to claim 18, wherein the typical power profile is determined from the typical route and a desired speed profile.

24. Method according to claim 18, wherein the method comprises the following additional steps:
the determination of a peak power of the power profile occurring in the operation of the vehicle and of the additional energy required for the operation of the electric motor (16) at peak power in addition to the energy supplied by the energy generating unit (11, 12, 16); and
the dimensioning of the energy storage device (8, 9) such that its capacity is at least equal to the required additional energy.
